(19) United States
(12) Patent Application Publication
(10) Pub. No.: US 2026/0313710 A1
(43) Pub. Date: Oct. 8, 2026

(54) METHOD AND DEVICE FOR USE IN A FIRST NODE

(71) Applicants: Yu CHEN, Shanghai (CN); Lu Wu, Shanghai (CN)

(72) Inventors: Yu CHEN, Shanghai (CN); Lu Wu, Shanghai (CN)

(73) Assignee: SHANGHAI CODUS TECHNOLOGY COMPANY LIMITED, Shanghai (CN)

(21) Appl. No.: 19/661,709

(22) Filed: Apr. 29, 2026

(51) Int. Cl. H04W 74/0833; H04W 68/02; H04W 72/0446; H04W 80/02

(52) U.S. Cl. CPC H04W 74/0833; H04W 68/02; H04W 72/0446; H04W 80/02

(57) ABSTRACT

This application discloses a method and an apparatus for use in a first node. The first node receives a first signaling, wherein the first signaling indicates a first identifier; transmits a second signaling in response to receiving a first signaling; and receives a third signaling, wherein the third signaling indicates the first identifier; a first processor is configured such that whether to respond to a third signaling depends on whether a success state of the first node is removed; a success state of the first node depends on an expiration of a first time window; each the first identifier corresponds to one success state of the first node. The method proposed in this application can reduce the impact of repeatedly responding to paging messages on the first node.

### CROSS REFERENCE TO RELATED APPLICATIONS

This application claims the priority benefit of Chinese Patent Application 202510428694.7, filed on Apr. 7, 2026, the full disclosure of which is incorporated herein by reference.

### BACKGROUND

### Technical Field

The present application relates to transmission methods in wireless communication systems, and to a method for avoiding repeated responses to subsequent paging messages.

### Related Art

Application scenarios in future wireless communication systems are becoming increasingly diversified, and different application scenarios impose different performance requirements on the system. To meet the different performance requirements of various application scenarios, it was decided to study the New Radio (NR, or Fifth Generation, 5G) technology at 3rd Generation Partner Project (3GPP) Radio Access Network (RAN) Plenary #72. The Work Item (WI) for NR was approved at 3GPP RAN Plenary #75, and the standardization of NR was initiated.

In communications, both Long Term Evolution (LTE) and 5G NR involve reliable and accurate reception of information, optimized energy efficiency ratio, determination of information validity, flexible resource allocation, scalable system architecture, efficient non-access stratum information processing, low service interruption and drop rate, and support for low power consumption. These are of great significance for normal communication between the second node and user equipment, reasonable scheduling of resources, and balancing of system load. They can be said to be the cornerstone for achieving high throughput, meeting communication requirements of various services, improving spectrum utilization, and enhancing service quality, and are indispensable for enhanced Mobile BroadBand (eMBB), Ultra Reliable Low Latency Communication (URLLC), and enhanced Machine Type Communication (eMTC). Ambient Internet of Things (AIoT) mainly focuses on low power consumption, passive communication, energy harvesting, and integration with cellular networks. Its development is driven by the evolution of 5G-A/6G technologies and the “dual carbon” goals. Through passive design, energy harvesting, and integration with cellular networks, AIoT solves the power consumption and deployment cost problems of traditional Internet of Things, and becomes a key technology of the digital-intelligent social infrastructure. In the AIoT communication procedure, paging is one of the core mechanisms, used to indicate which devices need to respond to service requests from the Core Network (CN).

As the scenarios and complexity of the system continue to increase, higher requirements are put forward for reducing the interruption rate, reducing latency, enhancing reliability, enhancing system stability, improving service flexibility, and saving power. Meanwhile, compatibility between different systems and different versions needs to be considered in system design.

### SUMMARY

Researchers have found that in a wireless communication system, how to avoid repeated responses to paging and whether to respond to paging carrying a same first identifier is a problem to be solved.

In view of the above problems, the present application provides a solution. Taking the signaling interaction between a Reader and a Device in an AIoT system as an example in the above problem description, the present application is also applicable to scenarios such as IAB or V2X, and achieves technical effects similar to the signaling interaction between the Reader and the Device. In addition, adopting a unified solution for different scenarios helps reduce hardware complexity and cost.

In one embodiment, interpretations of terms in the present application refer to definitions in the 3GPP specification TS36 series.

In one embodiment, interpretations of terms in the present application refer to definitions in the 3GPP specification TS38 series.

In one embodiment, interpretations of terms in the present application refer to definitions in the 3GPP specification TS37 series.

It should be noted that, without conflict, the embodiments in any node of the present application and the features in the embodiments may be applied to any other node. Without conflict, embodiments of the present application and the features in the embodiments may be combined with each other arbitrarily.

The present application provides a method in a first node,
characterized by comprising:
receiving a first signaling, the first signaling indicating a first identifier; transmitting a second signaling in response to receiving a first signaling; receiving a third signaling, the third signaling indicating the first identifier; a first processor, whether to respond to a third signaling depends on whether a success state of the first node is removed, comprising: responding to the third signaling when the success state is removed; not responding to the third signaling when the success state is not removed; wherein the responding to the third signaling comprises transmitting a fourth signaling, and a successful response to the first signaling triggers an addition of the success state.

In one embodiment, the problem to be solved by the present application includes how to determine whether the first node should respond to the third signaling in a scenario where subsequent third signaling carrying the first identifier may be received. In the above method, whether to respond to a third signaling depends on whether a success state of the first node is removed, thereby solving the above problem.

In one embodiment, advantages of the above method include: reducing signaling overhead, improving efficiency, guaranteeing paging performance, guaranteeing service transmission, better reducing power consumption of the first node, and prolonging battery life.

In one embodiment, the above method is simple to implement and suitable for communication systems applied with AI.

In one embodiment, the above method can determine whether to respond when receiving subsequent third signaling indicating the same service, optimizing the communication procedure and guaranteeing communication performance.

In one embodiment, the above method does not transmit a fourth signaling to respond to the third signaling when the success state of the first node is not removed, thereby reducing the power consumption.

According to one aspect of the present application, it is characterized in that:
a success state of the first node being removed depends on an expiration of a first time window; the first time window is started after a first signaling is successfully responded.

In one embodiment, advantages of the above method include: clarifying a timing when a success state of the first node is added, facilitating judgment of whether the third signaling is responded.

According to one aspect of the present application, it is characterized in that:
the first node does not respond to any received signaling indicating the first identifier within the first time window.

According to one aspect of the present application, it is characterized in that:
the success state being removed comprises the success state not being added.

According to one aspect of the present application, it is characterized in that:
each the first identifier corresponds to one success state of the first node.

According to one aspect of the present application, it is characterized in that:
the first processor does not respond to any received signaling indicating a second identifier before the first signaling is successfully responded; the first identifier and the second identifier respectively identify one service type.

In one embodiment, advantages of the above method include: avoiding confusion of signaling transmission caused by the first node responding to different services and affecting communication efficiency, and meanwhile reducing bits occupied by the first identifier to a certain extent and saving signaling overhead.

According to one aspect of the present application, it is characterized in that:
the first identifier indicated by the first signaling corresponds to a first service.

According to one aspect of the present application, it is characterized in that:
a first receiver receives a first signaling, the first signaling indicating a first identifier; a first transmitter transmits a second signaling in response to receiving a first signaling; the first receiver receives a third signaling, the third signaling indicating the first identifier; whether to respond to a third signaling depends on whether a success state of the first node is removed, comprising: responding to the third signaling when a success state of the first node is removed, wherein the responding to the third signaling comprises transmitting a fourth signaling; not responding to the third signaling when a success state of the first node is not removed.

The present application provides a first node for wireless communications, comprising:
a first receiver, configured to receive a first signaling, the first signaling indicating a first identifier;
a first transmitter, configured to transmit a second signaling in response to receiving a first signaling;
the first receiver is configured to receive a third signaling, the third signaling indicating a first identifier;
a first processor, configured such that whether to respond to a third signaling depends on whether a success state of the first node is removed, comprising: responding to the third signaling when a success state of the first node is removed, wherein the responding to the third signaling comprises transmitting a fourth signaling; not responding to the third signaling when a success state of the first node is not removed.

Specifically, according to one aspect of the present application, the first node is an IoT first node.

Specifically, according to one aspect of the present application, the first node is user equipment.

Specifically, according to one aspect of the present application, the first node is an access network device.

Specifically, according to one aspect of the present application, the first node is a vehicle-mounted terminal.

Specifically, according to one aspect of the present application, the first node is an aircraft.

Specifically, according to one aspect of the present application, the first node is a mobile phone.

Specifically, according to one aspect of the present application, the first node is a Device in an AIoT system.

The present application provides a method in a second node, characterized by comprising:
transmitting a first signaling, the first signaling indicating a first identifier; receiving a second signaling in response to transmitting a first signaling; transmitting a third signaling, the third signaling indicating the first identifier; a first processor, whether to respond to a third signaling depends on whether a success state of the first node is removed, comprising: responding to the third signaling when the success state is removed; not responding to the third signaling when the success state is not removed; wherein the responding to the third signaling comprises receiving a fourth signaling, and a successful response to the first signaling triggers an addition of the success state.

According to one aspect of the present application, it is characterized in that:
a success state of the first node being removed depends on an expiration of a first time window; the first time window is started after a first signaling is successfully responded.

According to one aspect of the present application, it is characterized in that:
the first node does not respond to any received signaling indicating the first identifier within the first time window.

According to one aspect of the present application, it is characterized in that:
the success state being removed comprises the success state not being added.

According to one aspect of the present application, it is characterized in that:
each the first identifier corresponds to one success state of the first node.

According to one aspect of the present application, it is characterized in that:
the first processor does not respond to any received signaling indicating a second identifier before the first signaling is successfully responded; the first identifier and the second identifier respectively identify one service type.

According to one aspect of the present application, it is characterized in that:
the first identifier indicated by the first signaling corresponds to a first service.

According to one aspect of the present application, it is characterized in that:
a second transmitter transmits a first signaling, the first signaling indicating a first identifier; a second receiver receives a second signaling in response to transmitting a first signaling; the second transmitter transmits a third signaling, the third signaling indicating the first identifier; whether to respond to a third signaling depends on whether a success state of the first node is removed, comprising: responding to the third signaling when a success state of the first node is removed, wherein the responding to the third signaling comprises receiving a fourth signaling; not responding to the third signaling when a success state of the first node is not removed.

The present application provides a second node, characterized by comprising:
a second transmitter, configured to transmit first signaling, the first signaling indicating a first identifier;
a second receiver, configured to receive a second signaling;
the second transmitter, configured to transmit a third signaling, the third signaling indicating the first identifier;
wherein whether the third signaling is responded depends on whether a success state of a receiver of the first signaling is removed, comprising: the third signaling is responded when the success state is removed; the third signaling is not responded when the success state is not removed;
wherein the third signaling being responded comprises a receiver of the first signaling transmitting a fourth signaling, and a successful response to the first signaling triggers the success state of a receiver of the first signaling being added.

Specifically, according to one aspect of the present application, the second node is an IoT second node.

Specifically, according to one aspect of the present application, the second node is a base station device.

Specifically, according to one aspect of the present application, the second node is a relay device.

Specifically, according to one aspect of the present application, the second node is a vehicle-mounted base station.

Specifically, according to one aspect of the present application, the second node is a gateway device.

Specifically, according to one aspect of the present application, the second node is a Reader in an AIoT system.

In one embodiment, compared with conventional solutions, the present application has the following advantages:

Clarifies the condition for the first node to respond to a signaling carrying the same identifier, optimizes the signaling interaction procedure, and avoids repeated responses to the same service.

Achieves a good balance between power saving and fast response to signaling carrying the same identifier.

Better supports transmission of services with high latency requirements and strong burstiness, including for example XR services.

For scenarios where the communication environment changes continuously, especially scenarios involving XR services, reduces latency and avoids impacts on communication caused by repeated responses to the same type of signaling.

Helps save power and reduce signaling overhead.

Compared with never responding to third signaling carrying the first identifier, determining whether to respond to the third signaling according to whether the success state is removed provides the possibility of reusing the first identifier in subsequent communications, such as subsequent paging, helping shorten the length of the first identifier and thereby reducing signaling overhead. Helps the first node respond to subsequent paging messages timely and correctly, thereby improving paging performance.

### BRIEF DESCRIPTION OF THE DRAWINGS

Other features, purposes, and advantages of the present application will become more apparent by reading the detailed description of non-limiting embodiments made with reference to the following drawings:

FIG. 1 illustrates a flowchart of performing measurements according to one embodiment of the present application;

FIG. 2 illustrates a schematic diagram of a network architecture according to one embodiment of the present application;

FIG. 3 illustrates a schematic diagram of a radio protocol architecture for a user plane and a control plane according to one embodiment of the present application;

FIG. 4 illustrates a schematic diagram of a first communication device and a second communication device according to one embodiment of the present application;

FIG. 5 illustrates a flowchart of wireless signal transmission according to one embodiment of the present application;

FIG. 6 illustrates a schematic diagram of receiving a signaling carrying a second identifier according to one embodiment of the present application;

FIG. 7 illustrates a schematic diagram of a first time window according to one embodiment of the present application;

FIG. 8 illustrates a structural block diagram of a processor for use in a first node according to one embodiment of the present application;

FIG. 9 illustrates a structural block diagram of a processor for use in a second node according to one embodiment of the present application.

Hereinafter, the technical solution of the present application will be further described in detail with reference to the accompanying drawings. It should be noted that, without conflict, the embodiments in the present application and the features in the embodiments may be arbitrarily combined with each other.

### Embodiment 1

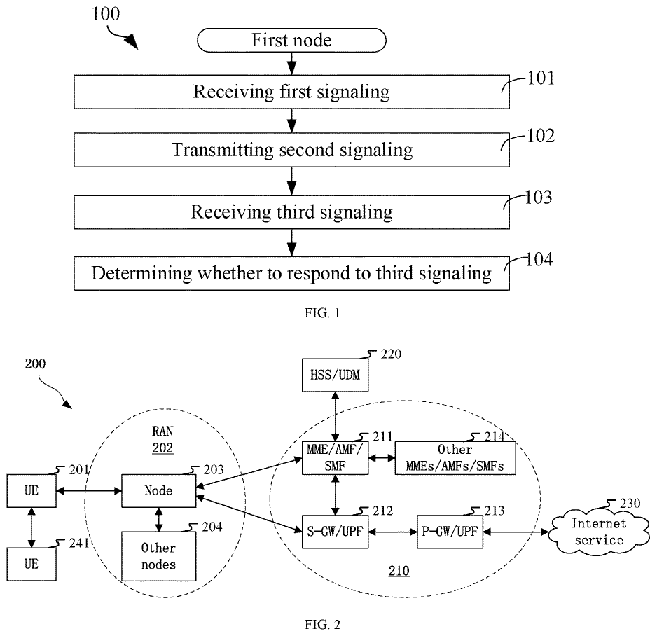

Embodiment 1 illustrates a flowchart of performing measurements according to one embodiment of the present application, as shown in FIG. 1. In FIG. 1, each box represents a step. It is particularly emphasized that the order of the boxes in the figure does not represent the chronological relationship between the indicated steps.

In Embodiment 1, the first node in the present application receives a first signaling in step 101, transmits a second signaling in step 102, receives a third signaling in step 103, and determines whether to respond to a third signaling in step 104.

Wherein, the first signaling indicates a first identifier;
in response to receiving a first signaling, a second signaling is transmitted;
the third signaling indicates the first identifier;
wherein whether to respond to a third signaling depends on whether a success state of the first node is removed, comprising: when a success state of the first node is removed, responding to the third signaling and transmitting a fourth signaling; when a success state of the first node is not removed, not transmitting a fourth signaling.

In one embodiment, the first node is UE (User Equipment).

In one embodiment, the present application is directed to AI (artificial intelligence).

In one embodiment, the AI includes machine learning.

In one embodiment, the first node refers to a communication device composed of hardware such as a baseband, radio frequency, and one or two SIM cards.

In one embodiment, the first node refers to a Device in an AIoT system.

In one embodiment, the first node refers to devices such as a camera, sensor, smart watch, smart switch, etc.

In one embodiment, the first node is in RRC (Radio Resource Control) Inactive state.

In one embodiment, the first node is in RRC (Radio Resource Control) Idle state.

In one embodiment, any parameter in the present application is either configured by the network or can be generated by the first node according to an internal algorithm, e.g., randomly.

In one embodiment, a value of any parameter in the present application, including but not limited to the length of the first time window, the first identifier, the second identifier, is finite unless otherwise specified.

In one sub-embodiment of the embodiment, an upper limit of a value of any parameter in the present application is 1024 times of 65536.

In one sub-embodiment of the embodiment, an upper limit of a value of any parameter in the present application is 65536 or 65535.

In one sub-embodiment of the embodiment, an upper limit of a value of any parameter in the present application is 1024.

In one sub-embodiment of the embodiment, an upper limit of a value of any parameter in the present application is 640 or 320.

In one embodiment, the present application is directed to NR.

In one embodiment, the present application is directed to a wireless communication network after NR.

In one embodiment, the serving cell refers to a cell where the UE camps. Performing cell search includes that the UE searches for a suitable cell of the selected PLMN (Public Land Mobile Network) or SNPN (Stand-alone Non-Public Network), selects the suitable cell to provide available services, and monitors the control channel of the suitable cell. This process is defined as camping on a cell; that is, a camped-on cell is the serving cell of the UE relative to this UE. Camping on a cell in RRC Idle state or RRC Inactive state has the following benefits: enabling the UE to receive system messages from the PLMN or SNPN; after registration, if the UE wishes to establish an RRC connection or resume a suspended RRC connection, the UE can do so by performing initial access on the control channel of the camped-on cell; the network can page the UE, enabling the UE to receive ETWS (Earthquake and Tsunami Warning System) and CMAS (Commercial Mobile Alert System) notifications.

In one embodiment, the first identifier is a real number.

In one embodiment, the first identifier is a positive number.

In one embodiment, the first identifier is a positive integer.

In one embodiment, the first identifier is dedicated to the first signaling.

In one embodiment, the first identifier is used to distinguish the service triggered by the first signaling.

In one embodiment, the first identifier is only related to the service triggered by the first signaling.

In one embodiment, the first identifier indicated by the first signaling corresponds to a first service.

In one embodiment, the first identifier is independent of a transmitter of the first signaling.

In one embodiment, the first identifier is independent of a receiver of the first signaling.

In one embodiment, the first identifier is an identifier of a service.

In one embodiment, the first identifier is generated from an identifier of the service.

In one embodiment, the first identifier includes 4 least significant bits of the service identifier, randomly generated by a transmitter.

In one embodiment, the first identifier is an identifier of a service group.

In one embodiment, the first identifier is generated from time.

In one sub-embodiment of the above embodiment, the time includes UTC (Coordinated Universal Time) time.

In one embodiment, the first identifier is an identifier of an AIoT server.

In one embodiment, the first identifier is a check bit of the first signaling.

In one embodiment, if the first identifiers carried by the first signaling are the same, services triggered by the first signaling are the same.

In one embodiment, if the first identifiers carried by the first signaling are different, services triggered by the first signaling are different.

In one embodiment, the first signaling indicating the first identifier means that the first signaling explicitly indicates the first identifier.

In one embodiment, the first signaling indicating the first identifier means that the first signaling implicitly indicates the first identifier.

In one embodiment, the first signaling indicating the first identifier means that the first signaling configures the first identifier.

In one embodiment, the first signaling indicating the first identifier means that the first signaling enables the first identifier.

In one embodiment, the first signaling is cell common.

In one embodiment, the first signaling is UE specific.

In one embodiment, the first signaling is transmitted to all Devices.

In one embodiment, the first signaling is Device specific.

In one embodiment, the first signaling is RRC (Radio Resource Control) signaling.

In one embodiment, the first signaling includes RRC signaling and MAC (Medium Access Control) CE (Control Element).

In one embodiment, the first signaling includes RRC signaling and DCI (Downlink Control Information).

In one embodiment, the first signaling includes one RRC signaling, and the one RRC signaling configures the first identifier.

In one embodiment, the first signaling includes one RRC signaling and one MAC CE, the one RRC signaling configures multiple identifiers, and the one MAC CE indicates the first identifier from the multiple identifiers.

In one embodiment, the first signaling includes one RRC signaling and one DCI, the one RRC signaling configures multiple identifiers, and the one DCI indicates the first identifier from the multiple identifiers.

In one embodiment, the first signaling includes a paging message.

In one embodiment, the first signaling is for completing a service of a paging message.

In one embodiment, the first signaling is for causing the first node to enter RRC_INACTIVE state from RRC_IDLE state.

In one embodiment, the first signaling is for causing the first node to enter RRC_CONNECTED state from RRC_IDLE state.

In one embodiment, the first signaling is for causing the first node to enter RRC_CONNECTED state from RRC_INACTIVE state.

In one embodiment, the first signaling is transmitted to a relay.

In one embodiment, the meaning that the first signaling is transmitted to a relay includes that the first signaling will be forwarded by the relay to other first nodes.

In one embodiment, the second signaling is a response to the first signaling.

In one embodiment, the second signaling is a physical layer signal.

In one embodiment, the second signaling is a PRACH (Physical Random Access Channel) signal.

In one embodiment, parameters of the second signaling are specified by the first signaling.

In one embodiment, parameters of the second signaling are calculated according to parameters of the first signaling.

In one embodiment, time-domain resources of the second signaling are specified by the first signaling.

In one embodiment, time-domain resources of the second signaling are implicitly specified by the first signaling.

In one embodiment, frequency-domain resources of the second signaling are specified by the first signaling.

In one embodiment, frequency-domain resources of the second signaling are implicitly specified by the first signaling.

In one embodiment, the third signaling and the first signaling are the same type of signaling.

In one embodiment, the third signaling and the first signaling being the same type of signaling includes that both require the first node to respond with the same signaling.

In one embodiment, services triggered by the first signaling and the third signaling are the same.

In one embodiment, the third signaling is a subsequent signaling of the first signaling.

In one embodiment, the services triggered by the third signaling and the first signaling are different.

In one embodiment, service triggered by the first signaling includes positioning.

In one embodiment, there is more than one transmitter of the first signaling.

In one embodiment, the positioning method includes OTDOA Positioning (Observed Time Difference Of Arrival Positioning).

In one embodiment, the positioning method includes A-GNSS Positioning (Assisted Global Navigation Satellite System Positioning).

In one embodiment, the positioning method includes E-CID Positioning (Enhanced Cell ID Positioning).

In one embodiment, the positioning method includes TBS Positioning (Terrestrial Beacon System Positioning).

In one embodiment, the positioning method includes Sensor based Positioning.

In one embodiment, the positioning method includes WLAN-based Positioning.

In one embodiment, the positioning method includes Bluetooth-based Positioning.

In one embodiment, the positioning method includes NR UL Positioning (Uplink Positioning).

In one embodiment, the positioning method includes NR DL TDOA Positioning (Downlink Time Difference Of Arrival Positioning).

In one embodiment, the positioning method includes NR DL AoD Positioning (Downlink Angle-of-Departure Positioning).

In one embodiment, the positioning method includes Multi-RTT Positioning (Multiple-Round Trip Time Positioning).

In one embodiment, the positioning method uses measurement results for positioning.

In one embodiment, whether to respond to a third signaling depends on whether a success state of the first node is removed.

In one embodiment, a success state of the first node corresponds to the first identifier.

In one embodiment, a success state of the first node being removed means that a success state of the first node corresponding to the first identifier is removed.

In one embodiment, a success state of the first node is controlled only by the first node itself.

In one embodiment, a success state of the first node is visible only to the first node itself.

In one embodiment, a success state of the first node needs to be maintained by the first node.

In one embodiment, a success state of the first node needing to be maintained by the first node includes that the first node needs to add or remove it.

In one embodiment, a success state of the first node being removed includes that a success state of the first node is changed to another state.

In one embodiment, a success state of the first node being removed includes that a success state of the first node is changed to an initial state or a failure state.

In one embodiment, the transmitting a fourth signaling is a response to receiving the third signaling.

In one embodiment, the fourth signaling is different from the second signaling.

In one embodiment, services indicated by the first signaling responded by the second signaling and services indicated by the third signaling responded by the fourth signaling are different.

In one embodiment, services indicated by the first signaling responded by the second signaling and services indicated by a third signaling not responded by the fourth signaling are the same.

In one embodiment, advantage of the above method is that it enables the first node to distinguish signaling that needs to be responded to, avoids repeated responses to signaling of the same service, causes unnecessary power consumption and computing power consumption, reduces signaling overhead, and improves communication efficiency, which is particularly suitable for low-latency, high-connection communication scenarios.

In one embodiment, the success state of the first node is for the first identifier.

In one embodiment, when the first node does not respond to the third signaling, reception of the third signaling triggers restarting of the first time window.

In one embodiment, the restarting the first time window includes setting a length of the first time window to twice that when it was first started.

In one embodiment, a length of the first identifier depends on a service corresponding to the first identifier.

In one embodiment, when a service corresponding to the first identifier is a command, a length of the first identifier is 1 bit.

In one embodiment, when a service corresponding to the first identifier is inventory counting, a length of the first identifier is more than 1 bit and no more than 16 bits.

In one embodiment, an advantage of the above method is that it can save the signaling overhead of the first identifier as much as possible.

### EMBODIMENT 2

Embodiment 2 illustrates a schematic diagram of a network architecture according to the present application, as shown in FIG. 2.

FIG. 2 illustrates a network architecture 200 of 5G NR, LTE (Long-Term Evolution), and LTE-A (Long-Term Evolution Advanced) systems. The 5G NR or LTE network architecture 200 may be referred to as a 5GS (5G System)/EPS (Evolved Packet System) 200 or some other suitable terminology. The 5GS/EPS 200 may include one or more UEs (User Equipment) 201, an NG-RAN (Next Generation Radio Access Network) 202, a 5GC (5G Core Network)/EPC (Evolved Packet Core) 210, an HSS (Home Subscriber Server)/UDM (Unified Data Management) 220, and Internet services 230. The 5GS/EPS may interconnect with other access networks, but these entities/interfaces are not shown for simplicity. As shown, the 5GS/EPS provides packet-switched services; however, those skilled in the art will readily appreciate that the various concepts presented throughout this application may be extended to networks providing circuit-switched services or other cellular networks. The NG-RAN includes a gNB (NR Node B) 203 and other gNBs 204. The gNB 203 provides user and control plane protocol terminations toward the UE 201. The gNB 203 may be connected to other gNBs 204 via an Xn interface (e.g., backhaul). The gNB 203 may also be referred to as a second node, a second node transceiver station, a radio second node, a radio transceiver, a transceiver function, a Basic Service Set (BSS), an Extended Service Set (ESS), a TRP (Transmission Reception Point), or some other suitable terminology. The gNB 203 provides an access point to the 5GC/EPC 210 for the UE 201. Examples of the UE 201 include a cellular phone, a smart phone, a Session Initiation Protocol (SIP) phone, a laptop computer, a Personal Digital Assistant (PDA), a satellite radio, non-terrestrial second node communications, satellite mobile communications, a Global Positioning System, a multimedia device, a video device, a digital audio player (e.g., an MP3 player), a camera, a game console, a drone, an aircraft, a narrowband Internet of Things device, a machine-type communication device, a land vehicle, an automobile, a wearable device, or any other similarly functioning device. Those skilled in the art may also refer to the UE 201 as a mobile station, a subscriber station, a mobile unit, a subscriber unit, a wireless unit, a remote unit, a mobile device, a wireless device, a wireless communications device, a remote device, a mobile subscriber station, an access first node, a mobile first node, a wireless first node, a remote first node, a handset, a user agent, a mobile client, a client, or some other suitable terminology. The gNB 203 connects to the 5GC/EPC 210 via an S1/NG interface. The 5GC/EPC 210 includes an MME (Mobility Management Entity)/AMF (Authentication Management Field)/SMF (Session Management Function) 211, other MME/AMF/SMFs 214, an S-GW (Service Gateway)/UPF (User Plane Function) 212, and a P-GW (Packet Data Network Gateway)/UPF 213. The MME/AMF/SMF 211 is a control node that processes signaling between the UE 201 and the 5GC/EPC 210. In general, the MME/AMF/SMF 211 provides bearer and connection management. All user IP (Internet Protocol) packets are transmitted through the S-GW/UPF 212, which itself connects to the P-GW/UPF 213. The P-GW provides UE IP address allocation as well as other functions. The P-GW/UPF 213 connects to the Internet services 230. The Internet services 230 include operator-corresponding Internet Protocol services, which may specifically include the Internet, an intranet, an IMS (IP Multimedia Subsystem), and packet-switched streaming services.

In one embodiment, the first node in the present application is the UE 201.

In one embodiment, the second node of the network node in the present application is the gNB 203.

In one embodiment, a radio link from the UE 201 to the NR Node B is an uplink.

In one embodiment, a radio link from the NR Node B to the UE 201 is a downlink.

In one embodiment, the UE 201 supports relay transmission.

In one embodiment, the UE 201 includes a mobile phone.

In one embodiment, the UE 201 is a vehicle including an automobile.

In one embodiment, the gNB 203 is a macro-cellular second node.

In one embodiment, the gNB 203 is a micro cell second node.

In one embodiment, the gNB 203 is a pico cell second node.

In one embodiment, the gNB 203 is a flying platform device.

In one embodiment, the gNB 203 is a satellite device.

### Embodiment 3

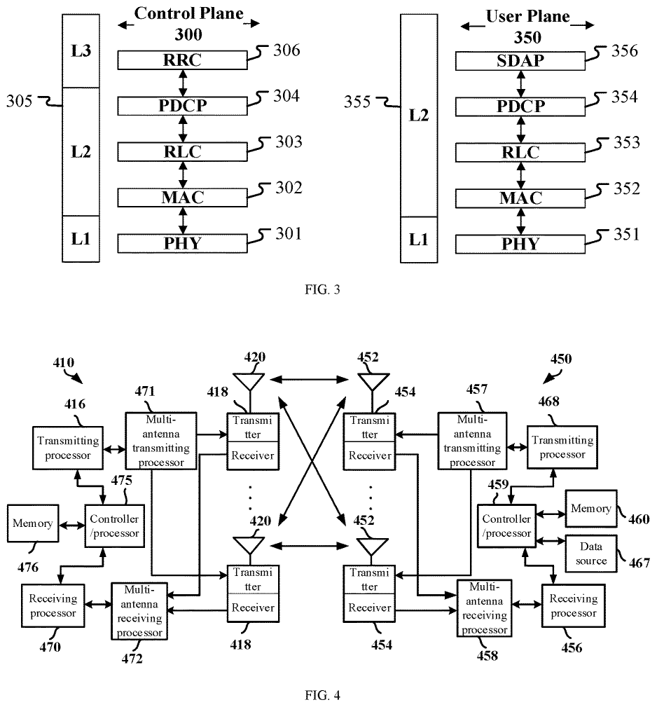

Embodiment 3 illustrates a schematic diagram of an embodiment of a radio protocol architecture for a user plane and a control plane according to the present application, as shown in FIG. 3. FIG. 3 is a schematic diagram illustrating an embodiment of a radio protocol architecture for a user plane 350 and a control plane 300. FIG. 3 presents the radio protocol architecture for the control plane 300 between a first node (UE, gNB) and a network node (gNB, UE), or between two UEs, in three layers: Layer 1, Layer 2, and Layer 3. Layer 1 (L1 layer) is the lowest layer and implements various PHY (physical layer) signal processing functions. The L1 layer will be referred to herein as the PHY 301. Layer 2 (L2 layer) 305 is above the PHY 301, and is responsible for the link between the first node and the network node, as well as between two UEs, via the PHY 301. The L2 layer 305 includes a MAC (Medium Access Control) sublayer 302, an RLC (Radio Link Control) sublayer 303, and a PDCP (Packet Data Convergence Protocol) sublayer 304, which terminate at the network node. The PDCP sublayer 304 provides multiplexing between different radio bearers and logical channels. The PDCP sublayer 304 also provides security by encrypting data packets and provides handover support for the first node between network nodes. The RLC sublayer 303 provides segmentation and reassembly of upper-layer packets, retransmission of lost packets, and reordering of packets to compensate for out-of-order reception due to HARQ. The MAC sublayer 302 provides multiplexing between logical and transport channels. The MAC sublayer 302 is also responsible for allocating various radio resources (e.g., resource blocks) in a cell among first nodes. The MAC sublayer 302 is also responsible for HARQ operations. The RRC (Radio Resource Control) sublayer 306 in Layer 3 (L3 layer) of the control plane 300 is responsible for acquiring radio resources (i.e., radio bearers) and configuring lower layers using RRC signaling between the network node and the first node. The PC5-S (PC5 Signaling Protocol) sublayer 307 is responsible for processing the signaling protocol of the PC5 interface. The radio protocol architecture of the user plane 350 includes Layer 1 (L1 layer) and Layer 2 (L2 layer). In the user plane 350, the radio protocol architecture for the first node and the network node is substantially the same as the corresponding layers and sublayers in the control plane 300 for the physical layer 351, the PDCP sublayer 354 in the L2 layer 355, the RLC sublayer 353 in the L2 layer 355, and the MAC sublayer 352 in the L2 layer 355, but the PDCP sublayer 354 also provides header compression for upper-layer packets to reduce radio transmission overhead. The L2 layer 355 in the user plane 350 also includes an SDAP (Service Data Adaptation Protocol) sublayer 356, which is responsible for mapping between QoS flows and Data Radio Bearers (DRBs) to support diverse services. An SRB may be regarded as a service or interface provided by the PDCP layer to higher layers, such as the RRC layer. In the NR system, SRBs include SRB1, SRB2, and SRB3, which are used to transmit different types of control signaling respectively. An SRB is a bearer between the UE and the access network, used to transmit control signaling including RRC signaling between the UE and the access network. SRB1 is of particular significance to the UE: after each UE establishes an RRC connection, it will have an SRB1 for transmitting RRC signaling, and most signaling is transmitted via SRB1. If SRB1 is interrupted or unavailable, the UE must perform RRC re-establishment; one SRB1 is established per RRC connection. SRB2 is generally only used to transmit NAS signaling or signaling related to security aspects; one SRB2 is established per RRC connection. The UE may not be configured with SRB3. Except for emergency services, the UE must establish an RRC connection with the network to perform subsequent communications. Although not illustrated, the first node may have several upper layers above the L2 layer 355. Also included are a network layer (e.g., IP layer) terminating at the P-GW on the network side and an application layer terminating at the other end of the connection (e.g., a remote UE, a server, etc.).

In one embodiment, the radio protocol architecture in FIG. 3 is applicable to the first node in the present application.

In one embodiment, the radio protocol architecture in FIG. 3 is applicable to the network node in the present application.

In one embodiment, the first node in the present application may lack one or more of SDAP 356, PDCP 354, and RLC 353.

In one embodiment, the first signaling in the present application is generated at the PHY 301 or MAC 302.

In one embodiment, the second signaling in the present application is generated at the PHY 351 or MAC 352.

In one embodiment, the third signaling in the present application is generated at the PHY 301 or MAC 302.

In one embodiment, the fourth signaling in the present application is generated at the PHY 351 or MAC 352.

### Embodiment 4

Embodiment 4 illustrates a schematic diagram of a first communication device and a second communication device according to one embodiment of the present application, as shown in FIG. 4. FIG. 4 is a block diagram of a first communication device 450 and a second communication device 410 communicating with each other in an access network.

The first communication device 450 includes a controller/processor 459, a memory 460, a data source 467, a transmit processor 468, a receive processor 456, and optionally a multi-antenna transmit processor 457, a multi-antenna receive processor 458, a transmitter/receiver 454, and an antenna 452.

The second communication device 410 includes a controller/processor 475, a memory 476, a receive processor 470, a transmit processor 416, and optionally a multi-antenna receive processor 472, a multi-antenna transmit processor 471, a transmitter/receiver 418, and an antenna 420.

In transmission from the second communication device 410 to the first communication device 450, at the second communication device 410, upper-layer packets from a core network are provided to the controller/processor 475. The controller/processor 475 implements Layer-2 (L2) functionality. In transmission from the second communication device 410 to the first communication device 450, the controller/processor 475 provides header compression, encryption, packet segmentation and reordering, multiplexing between logical and transport channels, and radio resource allocation for the first communication device 450 based on various priority metrics. The controller/processor 475 is also responsible for retransmission of lost packets and signaling to the first communication device 450. The transmit processor 416 and multi-antenna transmit processor 471 implement various signal processing functions for the L1 layer (i.e., physical layer). The transmit processor 416 performs coding and interleaving to facilitate Forward Error Correction (FEC) at the second communication device 410, and mapping of signal constellations based on various modulation schemes (e.g., Binary Phase Shift Keying (BPSK), Quadrature Phase Shift Keying (QPSK), M-ary Phase Shift Keying (M-PSK), M-ary Quadrature Amplitude Modulation (M-QAM)). The multi-antenna transmit processor 471 performs digital spatial precoding, including codebook-based precoding and non-codebook-based precoding, and beamforming processing on the coded and modulated symbols to generate one or more spatial streams. The transmit processor 416 then maps each spatial stream to subcarriers, multiplexes with reference signals (e.g., pilots) in the time domain and/or frequency domain, and then uses Inverse Fast Fourier Transform (IFFT) to generate a physical channel carrying a time-domain multi-carrier symbol stream. The multi-antenna transmit processor 471 then performs transmit analog precoding/beamforming operations on the time-domain multi-carrier symbol stream. Each transmitter 418 converts the baseband multi-carrier symbol stream provided by the multi-antenna transmit processor 471 into a radio frequency stream, which is then provided to different antennas 420.

In transmission from the second communication device 410 to the first communication device 450, at the first communication device 450, each receiver 454 receives a signal via its corresponding antenna 452. Each receiver 454 recovers information modulated onto a radio frequency carrier and converts the radio frequency stream into a baseband multi-carrier symbol stream provided to the receive processor 456. The receive processor 456 and multi-antenna receive processor 458 implement various signal processing functions for the L1 layer. The multi-antenna receive processor 458 performs receive analog precoding/beamforming operations on the baseband multi-carrier symbol stream from the receiver 454. The receive processor 456 converts the baseband multi-carrier symbol stream after receive analog precoding/beamforming operations from the time domain to the frequency domain using Fast Fourier Transform (FFT). In the frequency domain, physical layer data signals and reference signals are demultiplexed by the receive processor 456, where the reference signals are used for channel estimation, and the data signals are subjected to multi-antenna detection in the multi-antenna receive processor 458 to recover any spatial streams destined for the first communication device 450. Symbols on each spatial stream are demodulated and recovered in the receive processor 456 to generate soft decisions. The receive processor 456 then decodes and deinterleaves the soft decisions to recover upper-layer data and control signals transmitted by the second communication device 410 on the physical channel. The upper-layer data and control signals are then provided to the controller/processor 459. The controller/processor 459 implements L2 layer functions. The controller/processor 459 may be associated with the memory 460 that stores program codes and data. The memory 460 may be referred to as a computer-readable medium. In transmission from the second communication device 410 to the first communication device 450, the controller/processor 459 provides demultiplexing between transport and logical channels, packet reassembly, decryption, header decompression, control signal processing to recover upper-layer packets from the core network. The upper-layer packets are then provided to all protocol layers above the L2 layer. Various control signals may also be provided to L3 for L3 processing.

In transmission from the first communication device 450 to the second communication device 410, at the first communication device 450, upper-layer packets are provided to the controller/processor 459 using the data source 467. The data source 467 represents all protocol layers above the L2 layer. Similarly to the transmit functions at the second communication device 410 described in transmission from the second communication device 410 to the first communication device 450, the controller/processor 459 implements header compression, encryption, packet segmentation and reordering, and multiplexing between logical and transport channels based on radio resource allocation, implementing L2 layer functions for the user plane and control plane. The controller/processor 459 is also responsible for retransmission of lost packets and signaling to the second communication device 410. The transmit processor 468 performs modulation mapping and channel coding processing. The multi-antenna transmit processor 457 performs digital multi-antenna spatial precoding, including codebook-based precoding and non-codebook-based precoding, and beamforming processing. The transmit processor 468 then modulates the generated spatial streams into a multi-carrier/single-carrier symbol stream, which is subjected to analog precoding/beamforming operations in the multi-antenna transmit processor 457 and then provided to different antennas 452 via the transmitter 454. Each transmitter 454 first converts the baseband symbol stream provided by the multi-antenna transmit processor 457 into a radio frequency symbol stream and then provides it to the antenna 452.

In transmission from the first communication device 450 to the second communication device 410, functions at the second communication device 410 are similar to the receive functions at the first communication device 450 described in transmission from the second communication device 410 to the first communication device 450. Each receiver 418 receives radio frequency signals via its corresponding antenna 420, converts the received radio frequency signals into baseband signals, and provides the baseband signals to the multi-antenna receive processor 472 and the receive processor 470. The receive processor 470 and multi-antenna receive processor 472 jointly implement L1 layer functions. The controller/processor 475 implements L2 layer functions. The controller/processor 475 may be associated with the memory 476 that stores program codes and data. The memory 476 may be referred to as a computer-readable medium. In transmission from the first communication device 450 to the second communication device 410, the controller/processor 475 provides demultiplexing between transport and logical channels, packet reassembly, decryption, header decompression, control signal processing to recover upper-layer packets from the UE 450. Upper-layer packets from the controller/processor 475 may be provided to the core network.

In one embodiment, the first communication device 450 apparatus includes: at least one processor and at least one memory, the at least one memory including computer program code; the at least one memory and the computer program code are configured to be used with the at least one processor, and the first communication device 450 apparatus is configured to at least: receive a first signaling, the first signaling indicating a first identifier; transmit a second signaling in response to receiving a first signaling; receive a third signaling, the third signaling indicating a first identifier; a first processor, whether to respond to a third signaling depends on whether a success state of the first node is removed, comprising: responding to the third signaling when the success state is removed; not responding to the third signaling when the success state is not removed; wherein the responding to the third signaling comprises transmitting a fourth signaling, and a successful response to the first signaling triggers an addition of the success state.

In one embodiment, the first communication device 450 includes: a memory storing a computer-readable instruction program that, when executed by at least one processor, causes actions comprising: receiving a first signaling, the first signaling indicating a first identifier; transmitting a second signaling in response to receiving a first signaling; receiving a third signaling, the third signaling indicating the first identifier; a first processor, whether to respond to a third signaling depends on whether a success state of the first node is removed, comprising: responding to the third signaling when the success state is removed; not responding to the third signaling when the success state is not removed; wherein the responding to the third signaling comprises transmitting a fourth signaling, and a successful response to the first signaling triggers an addition of the success state.

In one embodiment, the second communication device 410 includes: at least one processor and at least one memory, the at least one memory including computer program code; the at least one memory and the computer program code are configured to be used with the at least one processor. The second communication device 410 is configured to at least: transmit a first signaling, the first signaling indicating a first identifier; receive a second signaling in response to transmitting a first signaling; transmit a third signaling, the third signaling indicating the first identifier; a first processor, whether to respond to a third signaling depends on whether a success state of the first node is removed, comprising: responding to the third signaling when the success state is removed; not responding to the third signaling when the success state is not removed; wherein the responding to the third signaling comprises receiving a fourth signaling, and a successful response to the first signaling triggers an addition of the success state.

In one embodiment, the second communication device 410 includes: a memory storing a computer-readable instruction program that, when executed by at least one processor, causes actions comprising: transmitting a first signaling, the first signaling indicating a first identifier; receiving a second signaling in response to transmitting a first signaling; transmitting a third signaling, the third signaling indicating the first identifier; a first processor, whether to respond to a third signaling depends on whether a success state of the first node is removed, comprising: responding to the third signaling when the success state is removed; not responding to the third signaling when the success state is not removed; wherein the responding to the third signaling comprises receiving a fourth signaling, and a successful response to the first signaling triggers an addition of the success state.

In one embodiment, the first communication device 450 corresponds to the first node in the present application.

In one embodiment, the first communication device 450 corresponds to a Device in an AIoT system in the present application.

In one embodiment, the second communication device 410 corresponds to a network node in the present application.

In one embodiment, the second communication device 410 corresponds to a Reader in an AIoT system in the present application.

In one embodiment, the first communication device 450 is a UE.

In one embodiment, the first communication device 450 is a vehicle-mounted terminal.

In one embodiment, the first communication device 450 is a mobile phone.

In one embodiment, the second communication device 410 is a relay.

In one embodiment, the second communication device 410 is a satellite.

In one embodiment, the second communication device 410 is an aircraft.

In one embodiment, the second communication device 410 is a second node.

In one embodiment, the receiver 454 (including antenna 452), receive processor 456, and controller/processor 459 are used for receiving the first signaling in the present application.

In one embodiment, transmitter 454 (including antenna 452), transmit processor 468, and controller/processor 459 are used for transmitting the second signaling in the present application.

In one embodiment, receiver 454 (including antenna 452), receive processor 456, and controller/processor 459 are used for receiving the third signaling in the present application.

In one embodiment, transmitter 454 (including antenna 452), transmit processor 468, and controller/processor 459 are used for transmitting the fourth signaling in the present application.

In one embodiment, transmitter 418 (including antenna 420), transmit processor 416, and controller/processor 475 are used for transmitting the first signaling in the present application.

In one embodiment, receiver 418 (including antenna 420), receive processor 470, and controller/processor 475 are used for receiving the second signaling in the present application.

In one embodiment, transmitter 418 (including antenna 420), transmit processor 416, and controller/processor 475 are used for transmitting the third signaling in the present application.

In one embodiment, receiver 418 (including antenna 420), receive processor 470, and controller/processor 475 are used for receiving the fourth signaling in the present application.

### Embodiment 5

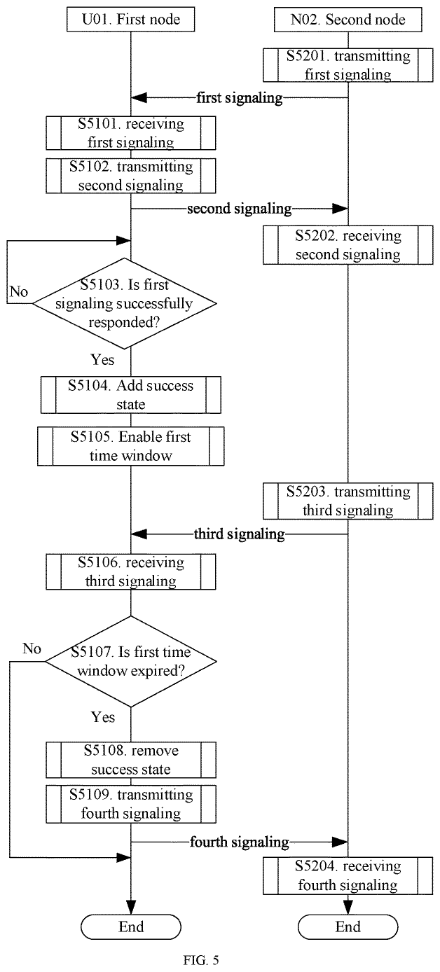

Embodiment 5 illustrates a flowchart of wireless signal transmission according to one embodiment of the present application, as shown in FIG. 5. In FIG. 5, U01 corresponds to the first node of the present application. It is particularly noted that the order in this example does not limit the signal transmission order and implementation order in the present application.

For the first node U01: receive a first signaling in step S5101; transmit a second signaling in step S5102; determine whether the first signaling is successfully responded in step S5103; if the first signaling is successfully responded, perform step S5104; otherwise, wait until the first signaling is successfully responded; add a success state in step S5104; start a first time window in step S5105; receive a third signaling in step S5106; determine whether a first time window expires in step S5107; if a first time window expires, perform step S5108; otherwise, do not perform step S5108; remove a success state in step S5108; transmit a fourth signaling in step S5109.

For the second node N02: transmit a first signaling in step S5201; receive a second signaling in step S5202; transmit a third signaling in step S5203; receive a fourth signaling in step S5204.

In Embodiment 5, the first signaling indicates a first identifier; step S5102 is performed in response to receiving a first signaling; the third signaling indicates the first identifier; whether to respond to a third signaling depends on whether a success state of the first node is removed, comprising: responding to the third signaling when the success state is removed; not responding to the third signaling when the success state is not removed; wherein the responding to the third signaling comprises transmitting a fourth signaling, and a successful response to the first signaling triggers an addition of the success state.

In Embodiment 5, a success state of the first node U01 being removed depends on an expiration of the first time window; the first time window is started after a first signaling is successfully responded. The success state being removed comprises the success state not being added.

In one embodiment, the second node N02 is a second node to which a serving cell of the first node U01 belongs.

In one embodiment, the second node N02 is a second node to which a PCell of the first node U01 belongs.

In one embodiment, the second node N02 is a second node to which a PSCell of the first node U01 belongs.

In one embodiment, the second node N02 is an MN (Master Node).

In one embodiment, the second node N02 is an SN (Secondary Node).

In one embodiment, the second node N02 is a Reader in an AIoT system.

In one embodiment, the first node U01 and the second node N02 are connected via a radio connection.

In one embodiment, the first node U01 and the second node N02 are connected via a wired connection.

In one embodiment, the first node U01 and the second node N02 are connected via a Uu interface.

In one embodiment, the first node U01 and the second node N02 are connected via an IAB interface.

In one embodiment, the first node U01 and the second node N02 are connected via a PC5 interface.

In one embodiment, the first signaling is a downlink signaling.

In one embodiment, the first signaling is an RRC signaling.

In one embodiment, the first signaling includes an RRC signaling.

In one embodiment, the first signaling is for a specific UE.

In one embodiment, the first signaling is transmitted in a unicast manner.

In one embodiment, the first signaling is transmitted on SRB1.

In one embodiment, the first signaling is RRCReconfiguration.

In one embodiment, the first signaling is a MAC layer control signaling.

In one embodiment, the first signaling is a MAC CE (Control Element).

In one embodiment, the first signaling is a physical layer control signaling.

In one embodiment, the first signaling is DCI (Downlink Control Information).

In one embodiment, the first signaling pages the first node U01.

In one embodiment, the first signaling schedules the first node U01.

In one embodiment, the second signaling is a random access signaling.

In one embodiment, the second signaling carries first data.

In one embodiment, the first data is scheduled by the first signaling.

In one embodiment, the first data is transmitted on time-frequency resources indicated by a first signaling.

In one embodiment, the first data is transmitted on a MAC CE.

In one embodiment, a success state of the first node U01 includes a complete transmission of the first data.

In one embodiment, the second signaling is signaling responding to paging.

In one embodiment, the third signaling schedules the first node U01.

In one embodiment, the fourth signaling responds to paging.

In one embodiment, the fourth signaling carries first data.

In one embodiment, first data carried by the fourth signaling and the second signaling is the same.

In one embodiment, when services indicated by the first signaling and the third signaling are the same, first data carried by the fourth signaling and the second signaling is the same.

In one embodiment, when services indicated by the first signaling and the third signaling are different, first data carried by the fourth signaling and the second signaling is different.

In one embodiment, the first signaling indicates the first identifier.

In one embodiment, the first signaling indicating the first identifier means that the first signaling explicitly indicates the first identifier.

In one embodiment, the first signaling indicating the first identifier means that the first signaling implicitly indicates the first identifier.

In one embodiment, the first signaling indicating the first identifier means that the first signaling configures the first identifier.

In one embodiment, the first signaling indicating the first identifier means that the first signaling enables the first identifier.

In one embodiment, the first identifier is a real number.

In one embodiment, the first identifier is a positive integer.

In one embodiment, the first identifier is used to distinguish a service indicated by the first signaling.

In one embodiment, the first identifiers are different, and services indicated by the first signaling are different.

In one embodiment, when first identifiers indicated by the first signaling and the third signaling are the same, services indicated by the first signaling and the third signaling are different.

In one embodiment, when first identifiers indicated by the first signaling and the third signaling are the same, the reason why services indicated by the first identifier and the third identifier are different is that the first identifier is recycled.

In one embodiment, an addition of a success state of the first node U01 depending on whether the first signaling is successfully responded comprises: if the first signaling is successfully responded, a success state of the first node U01 is added; if the first signaling is not successfully responded, a success state of U01 is not added.

In one embodiment, the first signaling being successfully responded means that a service indicated by the first signaling is completed.

In one embodiment, the first signaling being successfully responded means that the second signaling is successfully received by the second node N02.

In one embodiment, the first signaling being successfully responded means that the first data carried by the second signaling is completely received.

In one embodiment, a first signaling being successfully responded triggers starting of a first time window.

In one embodiment, a duration of the first time window is finite.

In one embodiment, a duration of the first time window is no more than 300 seconds.

In one embodiment, a duration of the first time window is no more than 600 seconds.

In one embodiment, the first time window comprises a time interval after a current moment.

In one embodiment, the first time window is an expected running time of a timer.

In one embodiment, the first time window is a running time of a timer.

In one embodiment, the first time window is controlled to be opened by the first node U01.

In one embodiment, the first time window is controlled to be closed by the first node U01.

In one embodiment, after the first signaling is successfully responded, a success state of the first node U01 is added.

In one embodiment, a success state of the first node U01 being removed depending on expiration of the first time window comprises: removing a success state of the first node U01 when the first time window expires; maintaining a success state of the first node U01 when the first time window is running.

In one embodiment, after the first signaling is successfully responded, a success state of the first node U01 is added and the first time window is started.

In one embodiment, the success state being removed comprises the success state not being added.

In one embodiment, if the first signaling is not successfully responded when the third signaling is received, a success state of the first node U01 is not added.

In one embodiment, if the first signaling is not successfully responded when the third signaling is received, the fourth signaling is transmitted to respond to the third signaling.

In one embodiment, the third signaling is paging or scheduling for the first node U01.

In one embodiment, the fourth signaling is a random access signaling.

In one embodiment, the fourth signaling is a retransmission signaling.

In one embodiment, if the first signaling is not successfully responded and the third signaling is successfully responded, a success state of the first node U01 is added and the first time window is started, wherein a success state and the first time window of the first node U01 correspond to the first identifier carried by the third signaling.

In one embodiment, when the first signaling is not successfully responded, the third signaling is a subsequent signaling of the first signaling, and services of the third signaling and the first signaling are the same.

In one embodiment, when the first signaling is successfully responded, the third signaling is not a subsequent signaling of the first signaling, and services of the third signaling and the first signaling are different.

### Embodiment 6

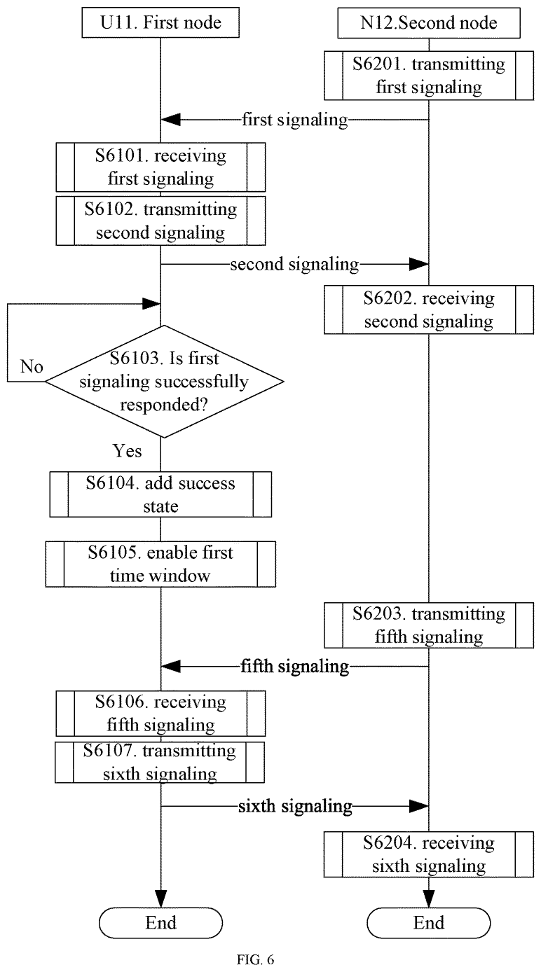

Embodiment 6 illustrates a schematic diagram of receiving a signaling carrying a second identifier according to one embodiment of the present application, as shown in FIG. 6. In FIG. 6, the fifth signaling carries the second identifier. It is particularly noted that the order in this example does not limit the signal transmission order and implementation order in the present application.

For the first node U11: receive a first signaling in step S6101; transmit a second signaling in step S6102; determine whether the first signaling is successfully responded in step S6103; if a first signaling is successfully responded, perform step S6104; otherwise, wait until a first signaling is successfully responded; add a success state in step S6104; start a first time window in step S6105; receive a fifth signaling in step S6106; transmit a sixth signaling in step S6107.

For the second node N12: transmit a first signaling in step S6201; receive a second signaling in step S6202; transmit a fifth signaling in step S6203; receive a sixth signaling in step S6204.

In Embodiment 6, the first node U11 does not respond to any received signaling indicating a second identifier before the first signaling is successfully responded; the first identifier and the second identifier respectively identify one service type.

In one embodiment, after the first signaling is successfully responded, the first node U11 transmits a sixth signaling in response to the fifth signaling.

In one embodiment, the second identifier indicated by the fifth signaling is different from a first identifier indicated by the first signaling.

In one embodiment, service types corresponding to the fifth signaling and the first signaling are different.

In one embodiment, the fifth signaling and the first signaling correspond to different phases of a same service.

In one embodiment, the first signaling pages the first node.

In one embodiment, the fifth signaling schedules the first node.

In one embodiment, the fifth signaling is a random access response.

In one embodiment, the second signaling is a random access signaling.

In one embodiment, the second signaling responds to paging.

In one embodiment, the second signaling carries first data.

In one embodiment, the sixth signaling responds to scheduling.

In one embodiment, the sixth signaling carries first data.

In one embodiment, the sixth signaling carries data via a MAC CE.

In one embodiment, the sixth signaling is transmitted on a PUSCH (Physical Uplink Shared Channel).

In one embodiment, time-frequency resources for first data carried by the sixth signaling are indicated by the fifth signaling.

In one embodiment, a condition for the fifth signaling to be responded is after the first signaling is successfully responded.

In one embodiment, a time when the fifth signaling is responded is after the first time window is started.

In one embodiment, a time when the fifth signaling is responded is during running of the first time window.

In one embodiment, a time when the fifth signaling is responded is after the first time window expires.

In one embodiment, the fifth signaling is transmitted by the second node N12 after the first signaling is transmitted.

In one embodiment, the fifth signaling cannot be responded before the first time window is started.

In one embodiment, an advantage of the above method is that bit occupancy of the first identifier and the second identifier can be saved, and meanwhile service confusion between the first signaling and the fifth signaling can be avoided to the greatest extent, normal transmission of signaling is guaranteed, and communication efficiency is improved.

In one embodiment, a time when the first time window is started is a time when the first signaling is successfully responded.

In one embodiment, a unit of duration of the first time window is millisecond (ms).

In one embodiment, a duration of the first time window is 20 ms.

In one embodiment, a duration of the first time window is 10 ms.

In one embodiment, a duration of the first time window is 5 ms.

In one embodiment, the first time window corresponds to the first identifier.

In one sub-embodiment of the above embodiment, within the first time window, the first node U11 responds to the fifth signaling, and the fifth signaling indicates the second identifier.

In one sub-embodiment of the above embodiment, within the first time window, the first node U11 does not respond to the third signaling, and the third signaling indicates the first identifier.

In one embodiment, after the fifth signaling is successfully responded, a second time window is started.

In one embodiment, the second time window corresponds to the second identifier.

In one sub-embodiment of the above embodiment, within the second time window, the first node U11 responds to the third signaling, and the third signaling indicates the first identifier.

In one embodiment, a time when the second time window is started is a time when the fifth signaling is successfully responded.

In one embodiment, a unit of duration of the second time window is millisecond (ms).

In one embodiment, a duration of the second time window is 20 ms.

In one embodiment, a duration of the second time window is 10 ms.

In one embodiment, a duration of the second time window is 5 ms.

In one embodiment, time periods in which the first time window and the second time window are located may overlap.

In one embodiment, time periods in which different first time windows are located do not overlap with each other.

In one embodiment, durations of different first time windows are the same.

In one embodiment, durations of different first time windows are different.

In one embodiment, durations of the first time window and the second time window are the same.

In one embodiment, durations of the first time window and the second time window are different.

In one embodiment, durations of the first time window and the second time window are determined by the first node itself.

In one embodiment, an advantage of the above method is that durations of the first time window and the second time window can be adaptively determined according to characteristics of the first node U11 itself, and more complex scenarios can be applied.

In one embodiment, durations of the first time window and the second time window are determined by the second node N12.

In one embodiment, an advantage of the above method is that the second node grasps more information and can plan durations of the first time window and the second time window from a global perspective.

In one embodiment, an advantage of the above method is that the second node N12 can autonomously determine a duration for transmitting subsequent signaling, avoid that transmitted signaling is not responded, and save power consumption.

In one embodiment, each the first identifier corresponds to one success state of the first node U11.

In one embodiment, success states of the first node U11 corresponding to different identifiers are independent of each other.

In one embodiment, that success states of the first node U11 corresponding to different identifiers are independent of each other comprises: when a first operation is performed on a success state of the first node U11 corresponding to one first identifier, a success state of the first node U11 corresponding to the second identifier is not affected; wherein performing the first operation comprises adding, removing and modifying.

In one embodiment, that success states of the first node U11 corresponding to different identifiers are independent of each other comprises: when a first operation is performed on a success state of the first node U11 corresponding to one second identifier, a success state of the first node U11 corresponding to the first identifier is not affected; wherein performing the first operation comprises adding, removing and modifying.

### Embodiment 7

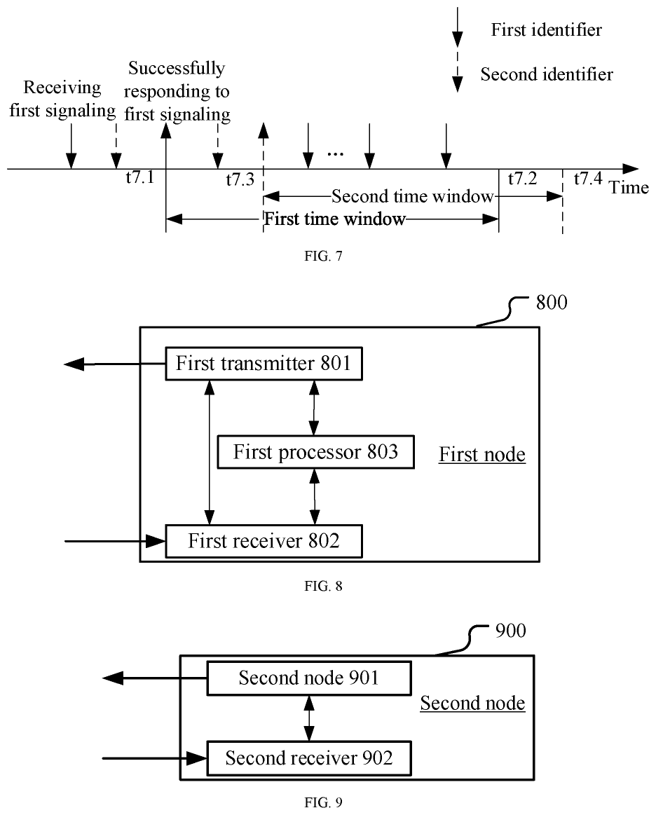

Embodiment 7 illustrates a schematic diagram of a first time window according to one embodiment of the present application, as shown in FIG. 7. In FIG. 7, the horizontal axis represents time, t7.1 is a start time of the first time window, t7.2 is an end time of a first time window, t7.3 is a start time of a second time window, t7.4 is an end time of a second time window. A solid one-way downward arrow represents receiving a signaling carrying a first identifier, a solid one-way upward arrow represents responding to a signaling carrying the first identifier, a dashed one-way downward arrow represents receiving a signaling carrying a second identifier, and a dashed one-way upward arrow represents responding to a signaling carrying a second identifier. It is particularly noted that the order in this example does not limit the signal transmission order and implementation order in the present application.

In Embodiment 7, each the first identifier corresponds to one success state of the first node. Before the first signaling is successfully responded, the first node does not respond to any received signaling indicating a second identifier. The first identifier and the second identifier respectively identify one service type. The first identifier indicated by the first signaling corresponds to a first service.

In one embodiment, before the first signaling is successfully responded, if the first node receives a signaling carrying a second identifier, the first node does not respond.

In one embodiment, after the first signaling is successfully responded, if the first node receives a signaling carrying a second identifier, the first node responds.

In one embodiment, the first time window is started when the first signaling is successfully responded.

In one embodiment, the second time window is started after a signaling carrying the second identifier is successfully responded.

In one embodiment, the first event and the second time window may overlap in time.

In one embodiment, durations of the first time window and the second time window may be different.

In one embodiment, within the first time window, the first node does not respond when receiving a signaling carrying a first identifier.

In one embodiment, within the second time window, the first node does not respond when receiving a signaling carrying a second identifier.

In one embodiment, in an overlapping portion of the first time window and the second time window, the first node does not respond when receiving a signaling carrying a first identifier or a second identifier.

In one embodiment, when the first time window expires, a success state of the first node corresponding to the first identifier is removed.

In one embodiment, when the second time window expires, a success state of the first node corresponding to the second identifier is removed.

In one embodiment, a success state of the first node corresponding to the first identifier and a success state of the first node corresponding to the second identifier occupy different bits.

In one embodiment, removing a success state of the first node corresponding to the first identifier does not affect a success state of the first node corresponding to the second identifier.

In one embodiment, removing a success state of the first node corresponding to the second identifier does not affect a success state of the first node corresponding to the first identifier.

In one embodiment, when the first signaling is successfully responded, a success state of the first node corresponding to the first identifier is added.

In one embodiment, when a first signaling carrying a second identifier is successfully responded, a success state of the first node corresponding to the second identifier is added.

In one embodiment, adding a success state of the first node corresponding to the first identifier does not affect a success state of the first node corresponding to the second identifier.

In one embodiment, adding a success state of the first node corresponding to the second identifier does not affect a success state of the first node corresponding to the first identifier.

In one embodiment, removing a success state of the first node refers to changing a corresponding bit from 1 to 0, and adding a success state of the first node refers to changing a corresponding bit from 0 to 1.

In one embodiment, removing a success state of the first node refers to changing a corresponding bit from 0 to 1, and adding a success state of the first node refers to changing a corresponding bit from 1 to 0.

In one embodiment, removing a success state of the first node is the same as not adding a success state of the first node, so removing a success state of the first node includes not adding a success state of the first node.

### Embodiment 8

Embodiment 8 illustrates a structural block diagram of a processor for use in a first node according to one embodiment of the present application, as shown in FIG. 8. In FIG. 8, a processor 800 in the first node includes a first transmitter 801, a first receiver 802, and a first processor 803.

In Embodiment 8, the first receiver 802 receives a first signaling, where the first signaling indicates a first identifier;
the first transmitter 801 transmits second signaling in response to receiving a first signaling;
the first receiver 802 receives a third signaling, where the third signaling indicates the first identifier;
the first processor 803 is configured such that whether to respond to a third signaling depends on whether a success state of the first node is removed, comprising: responding to the third signaling when the success state is removed; not responding to the third signaling when the success state is not removed; wherein the responding to the third signaling comprises transmitting a fourth signaling, and a successful response to the first signaling triggers an addition of the success state.

In one embodiment, a success state of the first node being removed depends on an expiration of a first time window; the first time window is started after a first signaling is successfully responded.

In one embodiment, the first node does not respond to any received signaling indicating the first identifier within the first time window.

In one embodiment, the success state being removed comprises the success state not being added.

In one embodiment, each the first identifier corresponds to one success state of the first node.

In one embodiment, the first processor 803 is configured not to respond to any received signaling indicating a second identifier before the first signaling is successfully responded; the first identifier and the second identifier respectively identify one service type.

In one embodiment, the first identifier indicated by the first signaling corresponds to a first service.

In one embodiment, the first node is a User Equipment (UE).

In one embodiment, the first node is a terminal supporting large delay differences.

In one embodiment, the first node is a terminal supporting NTN.

In one embodiment, the first node is an aircraft or a vessel.

In one embodiment, the first node is a mobile phone or a vehicle-mounted terminal.

In one embodiment, the first node is an IoT terminal or an industrial IoT terminal.

In one embodiment, the first node is a device supporting low-latency and high-reliability transmission.

In one embodiment, the first node is a Device in an AIoT system.

In one embodiment, the first transmitter 801 includes at least one of the antenna 452, the transmitter 454, the transmit processor 468, the multi-antenna transmit processor 457, the controller/processor 459, the memory 460, or the data source 467 in Embodiment 4.

In one embodiment, the first receiver 802 includes at least one of the antenna 452, the receiver 454, the receive processor 456, the multi-antenna receive processor 458, the controller/processor 459, the memory 460, or the data source 467 in Embodiment 4.

### Embodiment 9

Embodiment 9 illustrates a structural block diagram of a processor for use in a second node according to one embodiment of the present application, as shown in FIG. 9. In FIG. 9, the processor 900 in the second node includes a second transmitter 901 and a second receiver 902.

In Embodiment 9, the second transmitter 901 transmits a first signaling, where the first signaling indicates a first identifier; in response to transmitting a first signaling, the second receiver 902 receives a second signaling; the second transmitter 901 transmits a third signaling, where the third signaling indicates the first identifier; a first processor is configured such that whether to respond to a third signaling depends on whether a success state of the first node is removed, comprising: responding to the third signaling when the success state is removed; not responding to the third signaling when the success state is not removed; wherein the responding to the third signaling comprises receiving a fourth signaling, and a successful response to the first signaling triggers an addition of the success state.

In one embodiment, a success state of the first node being removed depends on an expiration of a first time window; the first time window is started after a first signaling is successfully responded.

In one embodiment, the success state being removed comprises the success state not being added.

In one embodiment, each the first identifier corresponds to one success state of the first node.

In one embodiment, a receiver of the first signaling does not respond to any received signaling indicating a second identifier before the first signaling is successfully responded; the first identifier and the second identifier respectively identify one service type.

In one embodiment, the first identifier indicated by the first signaling corresponds to a first service.

In one embodiment, the second node is a satellite.

In one embodiment, the second node is a terrestrial base station.

In one embodiment, the second node is a relay.

In one embodiment, the second node is an access point.

In one embodiment, the second node is a Reader in an AIoT system.

In one embodiment, the second transmitter 901 includes at least one of the antenna 420, the transmitter 418, the transmit processor 416, the multi-antenna transmit processor 471, the controller/processor 475, or the memory 476 in Embodiment 4.

In one embodiment, the second receiver 902 includes at least one of the antenna 420, the receiver 418, the receive processor 470, the multi-antenna receive processor 472, the controller/processor 475, or the memory 476 in Embodiment 4.

Those of ordinary skill in the art may understand that all or part of the steps in the above method may be implemented by a program instructing relevant hardware. The program may be stored in a computer-readable storage medium, such as a read-only memory, a hard disk, or an optical disk. Optionally, all or part of the steps in the above embodiments may also be implemented using one or more integrated circuits. Correspondingly, each module unit in the above embodiments may be implemented in the form of hardware or software function modules. The present application is not limited to any specific combination of software and hardware. User equipment, first node, and UE in the present application include, but are not limited to, wireless communication devices such as a drone, a communication module on a drone, a remote-controlled airplane, an aircraft, a small airplane, a mobile phone, a tablet computer, a notebook, a vehicle-mounted communication device, a wireless sensor, a network card, an IoT terminal, an RFID terminal, an NB-IoT terminal, an MTC (Machine Type Communication) terminal, an eMTC (enhanced MTC) terminal, a data card, a low-cost mobile phone, a low-cost tablet computer, a satellite communication device, a vessel communication device, and an NTN user equipment. A second node or system device in the present application includes, but is not limited to, wireless communication devices such as a macro-cellular base station, a micro-cellular base station, a home base station, a relay base station, a gNB (NR Node B), a TRP (Transmitter Receiver Point), an NTN base station, a satellite device, and a flying platform device.

The present invention may be embodied in other specified forms without departing from its core or essential characteristics. Therefore, the presently disclosed embodiments shall be regarded as illustrative rather than restrictive in all respects. The scope of the invention is defined by the appended claims rather than the foregoing description, and all changes that come within the meaning and range of equivalency of the claims are therefore intended to be embraced therein.

What is claimed is:

1. A method in a first node for wireless communications, comprising:
receiving a first signaling, the first signaling indicating a first identifier; the first signaling paging the first node;
transmitting a second signaling in response to receiving a first signaling; the second signaling being a random access signaling;
receiving a third signaling, the third signaling indicating the first identifier; the third signaling and the first signaling being of a same type;
whether to respond to a third signaling depends on whether a success state of the first node is removed, comprising: responding to the third signaling when the success state is removed; not responding to the third signaling when the success state is not removed;
wherein the responding to the third signaling comprises transmitting a fourth signaling, the fourth signaling being a random access signaling; successful responding to the first signaling triggers the success state being added; the first node is a Device in an AIoT system; a success state of the first node corresponds to the first identifier; a success state of the first node is added after the first signaling is successfully responded.

2. The method in a first node according to claim 1, wherein
the success state being removed comprises the success state not being added.

3. The method in a first node according to claim 1, wherein
a success state of the first node being removed comprises a success state of the first node being changed to a failure state.

4. The method in a first node according to claim 1, wherein
the success state of the first node is for the first identifier.

5. The method in a first node according to claim 1, wherein
the first identifier is any one of a first type of identifiers; the success state is any one of a first type of success states; identifiers in the first type of identifiers are in one-to-one correspondence with success states in the first type of success states.

6. The method in a first node according to claim 2, wherein
the first identifier is any one of a first type of identifiers; the success state is any one of a first type of success states; identifiers in the first type of identifiers are in one-to-one correspondence with success states in the first type of success states.

7. The method in a first node according to claim 3, wherein
the first identifier is any one of a first type of identifiers; the success state is any one of a first type of success states; identifiers in the first type of identifiers are in one-to-one correspondence with success states in the first type of success states.

8. The method in a first node according to claim 1, wherein
the first signaling and the third signaling are generated at a MAC layer.

9. The method in a first node according to claim 2, wherein
the first signaling and the third signaling are generated at a MAC layer.

10. The method in a first node according to claim 3, wherein
the first signaling and the third signaling are generated at a MAC layer.

11. The method in a first node according to claim 1, wherein
time-domain resources of the second signaling are specified by the first signaling.

12. The method in a first node according to claim 1, wherein
a success state of the first node being added depends on the first signaling being successfully responded.

13. A method in a second node for wireless communications, comprising:
transmitting a first signaling, the first signaling indicating a first identifier; the first signaling paging a first node;
receiving a second signaling; the second signaling being a random access signaling; the second signaling responding to the first signaling;
transmitting a third signaling, the third signaling indicating the first identifier; the third signaling and the first signaling being of a same type;
wherein whether the third signaling is responded depends on whether a success state of a receiver of the first signaling is removed, comprising: the third signaling being responded when the success state of a receiver of the first signaling is removed; the third signaling not being responded when the success state of a receiver of the first signaling is not removed; the third signaling being responded comprises a receiver of the first signaling transmitting a fourth signaling; the fourth signaling is a random access signaling; successful responding to the first signaling triggers the success state of a receiver of the first signaling being added; a receiver of the first signaling is a Device in an AIoT system; the second node is a Reader in an AIoT system; a success state of the first node corresponds to the first identifier; a success state of the first node is added after the first signaling is successfully responded.

14. The method in a second node according to claim 13, wherein
the success state being removed comprises the success state not being added or being changed to a failure state.

15. The method in a second node according to claim 13, wherein
the first signaling and the third signaling are generated at a MAC layer.

16. The method in a second node according to claim 13, wherein
time-domain resources of the second signaling are specified by the first signaling.

17. A second node for wireless communications, comprising:
a second transmitter, transmitting a first signaling, the first signaling indicating a first identifier; the first signaling paging the first node;
a second receiver, receiving a second signaling; the second signaling being a random access signaling; the second signaling responding to the first signaling;
the second transmitter, transmitting a third signaling, the third signaling indicating the first identifier; the third signaling and the first signaling being of a same type;
wherein whether the third signaling is responded depends on whether a success state of a receiver of the first signaling is removed, comprising: the third signaling being responded when the success state of a receiver of the first signaling is removed; the third signaling not being responded when the success state of a receiver of the first signaling is not removed; the third signaling being responded comprises a receiver of the first signaling transmitting a fourth signaling; the fourth signaling is a random access signaling; successful responding to the first signaling triggers the success state of a receiver of the first signaling being added; a receiver of the first signaling is a Device in an AIoT system; the second node is a Reader in an AIoT system; a success state of the first node corresponds to the first identifier; a success state of the first node is added after the first signaling is successfully responded.

18. The second node according to claim 17, wherein
the success state being removed comprises the success state not being added or being changed to a failure state.

19. The second node according to claim 17, wherein
the first signaling and the third signaling are generated at a MAC layer.

20. The second node according to claim 17, wherein
time-domain resources of the second signaling are specified by the first signaling.
